(19) United States
(12) Patent Application Publication
(10) Pub. No.: US 2008/0263244 A1
(43) Pub. Date: Oct. 23, 2008

(54) COMPRESSION CONTROL DEVICE AND METHOD

(76) Inventor: Makio MIZUNO, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/968,677

(22) Filed: Jan. 3, 2008

(30) Foreign Application Priority Data
Apr. 17, 2007 (JP) 2007-107985

(51) Int. Cl. G06F 13/00

(52) U.S. Cl. 710/68

(57) ABSTRACT

The present invention provides a compression control device for controlling the compression of data transceived in a storage system constituted by a plurality of apparatuses which include a storage device. The compression control device decides a compression control method for at least one apparatus constituting the storage system based on configuration information related to the configuration of the storage system, and controls at least one of the plurality of apparatuses such that the at least one apparatus carries out compression in accordance with the decided compression control method.

### CROSS-REFERENCE TO PRIOR APPLICATION

This application relates to and claims the benefit of priority from Japanese Patent Application number 2007-107985, filed on Apr. 17, 2007, the entire disclosure of which is incorporated herein by reference.

### BACKGROUND OF THE INVENTION

1. Field of the Invention

The present invention generally relates to controlling the compression of data transceived in a storage system.

2. Description of the Related Art

The volume of data being stored by companies has steadily risen in recent years in line with advances in information and communications technologies. Companies use storage systems to store large quantities of data stably and reliably, and as the volume of data increases, companies are being compelled to invest more in storage systems than ever before. Further, the increase in data volume is also impacting communication network traffic. In a communication network, transfer performance is degraded by the transceiving of data in excess of the throughput capabilities of the transmission channel.

Data compression is one method of solving for these problems. Compressing data makes it possible to hold down on the amount of capacity being used in a storage resource of a storage system, and as a result, expenses related to the augmentation of storage resources can be reduced. Further, in a communication network, data compression can cut down on the volume of data being transceived, making it possible to alleviate transfer performance degradation.

As technology related to the compression of data, for example, Japanese Patent Laid-open No. 5-250307 and Japanese Patent Laid-open No. 6-133123 are known.

However, data compression consumes processing power, memory and other resources of the device that carries out the compression, and therefore, although temporary in nature, adversely affects the processing performance of this device. Further, it is a known fact that recompressing data that has already been compressed has no effect. Therefore, it is desirable that data compression be carried out efficiently by avoiding wasteful redundant compression.

Normally, if data targeted for compression is file level data, it is possible to determine whether or not this data is compressed by the file extension. By contrast, in a storage system, since data is processed at the block level vice the file level, it is not possible to determine whether received data is compressed or not.

### SUMMARY OF THE INVENTION

Accordingly, an object of the present invention is to efficiently compress data transceived in a storage system.

A compression control device is comprised. The compression control device controls the compression of data in a storage system constituted from a plurality of apparatuses which include a storage device. The compression control device, based on configuration information related to the configuration of the storage system, decides a compression control method for at least one of the apparatuses constituting the storage system, and controls at least one of the plurality of apparatuses such that the at least one apparatus carries out compression in accordance with this decided compression control method.

### BRIEF DESCRIPTION OF THE DRAWINGS

FIG. 1 is a diagram showing an example of the constitution of a storage system comprising a compression control device related to a first embodiment;

FIG. 2 is a diagram showing an example of the constitution of a management terminal related to the first embodiment;

FIG. 3 is a diagram showing an example of a node management table;

FIG. 4 is a diagram showing an example of a path segment management table;

FIG. 5 is a diagram showing an example of a compression management table;

FIG. 6 is a diagram showing an example of the constitution of a storage device related to the first embodiment;

FIG. 7 is a flowchart of processing executed by a table preparation PG 431;

FIG. 8 is a flowchart of processing executed by a performance monitoring PG 432;

FIG. 9 is a flowchart of processing executed when a control target node receives data;

FIG. 10 is a diagram showing an example of the constitution of a storage system comprising a compression control device related to a second embodiment;

FIG. 11 is a diagram showing an example of a compression management table related to the second embodiment;

FIG. 12 is a flowchart of processing executed when a storage device related to the second embodiment receives data; and

FIG. 13 is a diagram showing a variation of the compression management table related to the second embodiment.

### DETAILED DESCRIPTION OF THE PREFERRED EMBODIMENTS

In one embodiment, a compression control device comprises configuration information related to the configuration of a storage system constituting a plurality of apparatuses which include a storage device; a compression control method decision unit, which decides a compression control method for at least one of the apparatuses constituting the storage system based on the configuration information; and a compression control unit, which controls at least one of the plurality of apparatuses such that the at least one apparatus carries out compression according to the decided compression control method.

The configuration information, for example, is stored in a storage resource comprised in the compression control device. Further, “controls at least one of the plurality of apparatuses such that the at least one apparatus carries out compression according to the decided compression control method” can be the sending of some sort of command to at least one apparatus (for example, the sending of a command indicating a compression control method), or the sending of some sort of command (for example, a command for not executing compression) to an apparatus beside the at least one apparatus, or the sending of some sort of command (for example, a command for storing information as to which apparatus will execute compression and/or the compression rate to be used (or what value to make the parameter that affects the compression rate (hereinafter, a parameter that affects the compression rate may be called a “compression control parameter”))) to all of the plurality of apparatuses.

Further, the compression control method, for example, can stipulate whether or not compression is carried out, or can stipulate what compression rate to use (or what value to make the compression control parameter) when compression is carried out.

In one embodiment, the configuration information comprises apparatus information and communication channel information. Apparatus information denotes whether or not each of the plurality of apparatuses constituting the storage system has a compression function. Communication channel information denotes, for each of a plurality of communication channels formed by the plurality of apparatuses constituting the storage system, the combination of apparatuses which form the communication channel, and the order in which data flows for the plurality of apparatuses forming the communication channel. The compression control method decision unit can decide, for each of the plurality of communication channels and based on the apparatus information and the communication channel information, one of the plurality of apparatuses forming the communication channel is the compression execution apparatus which is the apparatus that carries out data compression. The compression control unit can control at least one of the plurality of apparatuses such that the decided compression execution apparatus carries out data compression for each of the communication channels.

In one embodiment, the compression control method decision unit can decide, for each of the communication channels and based on the apparatus information and communication channel information, that the apparatus located the furthest upstream in the data flow, among the apparatuses which are a plurality of apparatuses forming the communication channel and which have the compression function, is the compression execution apparatus. Thus, for example, if the apparatus furthest upstream in the communication channel (first apparatus) does not have the compression function, but the apparatus located downstream by one therefrom (second apparatus) does have the compression function, the compression control method decision unit can make the second apparatus the compression execution apparatus.

In one embodiment, the configuration information further comprises transfer performance information. Transfer performance information denotes, for each of the communication channels, the transfer performance in each communication segment of the communication channel. The compression control method decision unit can decide, for each of the communication channels and based on the configuration information, communication channel information, and transfer performance information, that the apparatus located immediately prior to a low-transfer-performance communication segment, among the apparatuses which are a plurality of apparatuses forming the communication channel and which have the compression function, is the compression execution apparatus.

As used here, “low-transfer-performance communication segment” can be a communication segment with transfer performance that is lower than a prescribed threshold value, or it can be the communication segment with the lowest transfer performance in a single communication channel.

Further, a communication segment, for example, is formed by an apparatus-to-apparatus connection. In other words, the two ends of a communication segment are both apparatuses. Then, the above-mentioned “apparatus located immediately prior” is the apparatus upstream of the two end apparatuses when the upstream side apparatus of the apparatuses at the two ends of the communication segment has the compression function, and when the upstream side apparatus of the apparatuses at the two ends of the communication segment does not have the compression function, the apparatus, which is the closest to this upstream side apparatus, which has the compression function, and which is further upstream than this upstream side apparatus, becomes the above-described “apparatus located immediately prior.”

In one embodiment, the transfer performance is the data communication rate and/or the anticipated value of the data communication rate.

In one embodiment, a transfer performance measurement unit, which either regularly or irregularly measures the transfer performance of a communication segment in each of the communication channels is also provided. The transfer performance denoted by the transfer performance information is either (1) or (2) below:
(1) the transfer performance at a prescribed point in time measured by the transfer performance measurement unit;
(2) an average value of transfer performances at a plurality of points in time measured by the transfer performance measurement unit.

In one embodiment, transfer performance information denotes a history of transfer performances. The histories of the transfer performance for each of the communication segments in each of the communication channels are updated by adding a transfer performance measured by the transfer performance measurement-unit. A performance change determination unit which determines whether or not the low-transfer-performance communication segment has shifted to another communication segment for each of the communication channels is also provided. When the performance change determination unit determines that the low-transfer-performance communication segment has shifted to another communication segment for a certain communication channel, the compression control method decision unit can decide that the apparatus which is located immediately prior to the other low-transfer-performance communication segment and which has the compression function is the compression execution apparatus for this certain communication channel, and the compression control unit can control at least one of the plurality of apparatuses such that the decided compression execution apparatus carries out data compression for this certain communication channel.

In one embodiment, the compression control method decision unit can adjust, based on transfer performance subsequent to the shift of the low-transfer-performance communication segment, either the compression rate or the compression control parameter when the decided compression execution apparatus compresses data. The compression control unit can send the adjusted compression rate or compression control parameter to the compression execution apparatus. The compression execution apparatus can receive the compression rate, decide a compression control parameter for carrying out compression at this compression rate, and carry out compression using the decided compression control parameter and a prescribed algorithm. Further, the compression execution apparatus can receive the compression control parameter, and carry out compression using the received compression control parameter and the prescribed algorithm.

In one embodiment, the compression control method decision unit can decide, based on the transfer performance denoted by the transfer performance information, either a compression rate or a compression control parameter when the compression execution apparatus, which is the apparatus that carries out compression among the plurality of apparatuses, compresses data. The compression control unit can send either the decided compression rate or compression control parameter to the compression execution apparatus.

In one embodiment, the compression control method decision unit can change either the compression rate or compression control parameter when the compression execution apparatus compresses data, based on the transfer performance denoted by updated transfer performance information by the transfer performance measurement unit. The compression control unit can send either the updated compression rate or compression control parameter to the compression execution apparatus. The compression control method decision unit can change either the compression rate or compression control parameter each time the transfer performance changes, or it can change either the compression rate or compression control parameter when the amount of the transfer performance change is greater than a prescribed threshold value.

In one embodiment, the configuration information comprises data type information denoting the type of data in the storage system. The compression control method decision unit can decide whether or not to carry out data compression for each data type based on the data type information for a prescribed apparatus which constitutes the storage system. The compression control unit can control the prescribed apparatus such that the prescribed apparatus carries out data compression for the data type decided by the compression control method decision unit.

In one embodiment, when the data type is either a log or a backup, the compression control method decision unit can decide that compression is carried out for the data.

In one embodiment, configuration information comprises logical volume information, which denotes identification information for a logical volume in which data handled by a prescribed apparatus is stored, and the intended use therefor. The compression control method decision unit can decide, based on the intended use of each of logical volumes indicated in the logical volume information, whether or not to carry out compression for the data stored in the logical volume for each of the logical volumes for prescribed apparatus constituting the storage system. The compression control unit can control a prescribed apparatus such that the prescribed apparatus carries out the compression of data stored in a logical volume decided by the compression control method decision unit.

Two or more of the above-described plurality of embodiments can be arbitrarily combined. Further, the compression function can also be called the compression unit. Further, the respective units described hereinabove (for example, the compression control method decision unit, compression control unit, transfer performance measurement unit, and performance change determination unit) can be constructed from hardware, computer programs, or a combination thereof (for example, one unit can be realized via a computer program, and the remainder can be realized via hardware). A computer program is read in and executed by a prescribed processor. Further, a storage area residing in a hardware resource, such as a memory, can also be used as needed when a computer program is read into a processor and information processing is carried out. Further, a computer program can be installed in a computer from a storage medium such as a CD-ROM, or it can be downloaded to a computer via a communications network.

A number of embodiments of the present invention will be explained in detail hereinbelow by referring to the figures. Furthermore, the present invention is not limited by these embodiments.

### First Embodiment

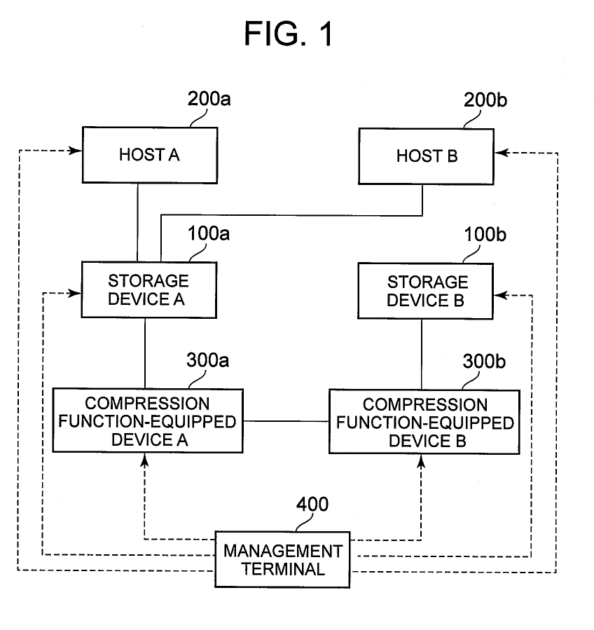

FIG. 1 is a diagram showing an example of the constitution of a storage system comprising a compression control device related to a first embodiment of the present invention.

A storage system related to this embodiment (may be called “this system” hereinafter) comprises one or more storage devices 100, one or more host computers (host) 200, and a management terminal 400. A storage device 100 is connected to one or more hosts 200 and one or more other storage devices 100 via a communication network (not shown in the figure). The communication network between a host 200 and a storage device 100, and between a storage device 100 and a storage device 100 can be a SAN (Storage Area Network) or an IP (Internet Protocol) network, or the storage devices can be directly connected. A compression function-equipped device 300, which has functions for compressing and decompressing data (hereinafter referred to simply as the “compression function”), can also be provided on the channel between a host 200 and a storage device 100, and the channel between a storage device 100 and a storage device 100.

The management terminal 400 is respectively connected to either all or a portion of the nodes (here, the storage devices 100, hosts 200 and compression function equipped device 300) constituting the storage system. Fundamentally, the management terminal 400 is connected to all the nodes, but it is not necessarily connected to a node, which clearly does not have the compression function, and which does not require control (hereinafter, “compression control”) related to compression (decompression). Hereinafter, a node, which is connected to the management terminal 400, and for which compression control is carried out by the management terminal 400, is called a “control target node”. The connection between the management terminal 400 and a control target node can be a SAN or an IP network, or it can be a direct devices-to-device connection, the same as the connections between a host 200 and a storage device 100, and between two storage devices 100. Further, the connections between the management terminal 400 and the control target nodes, and all the connections between nodes can be carried out via the same communications network.

The management terminal 400 coordinates with the respective control target nodes to carry out compression control for each node. For example, when data is sent from one node to another node (hereinafter, the one node, which is the source, will be called the “sending node”, and the other node, which is the destination, will be called the “receiving node”), a plurality of nodes, including the sending node, reside on the path over which the data passes, and a plurality of these nodes may have the compression function. The management terminal 400 decides which of the plurality of nodes having this compression function is to be subjected to compression, and notifies the contents of this decision to all the nodes on this path. Each node on the path acts in accordance with this notification, carrying out data compression when it is specified as the node to carry out compression, and not carrying out compression when it is not specified to carry out compression. In this embodiment, the compression node decision and notification are carried out across-the-board for either all the paths in this system, or for an arbitrarily selected portion of the paths (hereinafter referred to as “control target path”).

Further, the management terminal 400 either regularly or irregularly measures the transfer performance (communication speed and data loss ratio) in a segment, which is the smallest unit constituting a path, and is formed by a node-to-node connection (hereinafter, “path segment”). The management terminal 400 can also decide the node that will carry out compression and the compression rate at compression based on the results of measuring transfer performance. Further, when a change occurs relative to the node that will carry out compression or the compression rate at compression due to a change in the transfer performance, the management terminal 400 notifies the control target node of the contents of this change. Hereinafter, the notification for compression control, which the management terminal 400 carries out for the control target node, will be called the “compression control notification”. A detailed explanation of the management terminal 400 will be given below.

Furthermore, in this embodiment, the management terminal 400 provides functions vital for compression control, but this does not mean that the management terminal 400 is always necessary. For example, if a storage device 100 or host 200 comprises the functions provided by this management terminal 400, this system could also be constituted from a storage device 100 and a host 200 (and in some cases, a compression function-equipped device 300 as well).

A host 200 reads and writes data from and to a storage device 100. A host 200 can either have the compression function or not have the compression function. A host 200 that has the compression function can either send write-targeted data (hereinafter, “write data”) to a storage device 100 after compressing the write data, or it can send write-data to a storage device 100 without compressing this write-data. A host 200 that has the compression function can switch between compressing and not compressing write-data to be sent to a storage device 100 in accordance with the contents of a compression control notification from the management terminal 400.

A storage device 100 stores write-data received from a host 200 in a storage resource under its own control (for example, an area of cache memory or a logical volume). Further, a storage device 100 reads desired data from a storage resource in accordance with an indication from a host 200, and sends this read-out data (hereinafter “read-data”) to the host 200. Furthermore, a storage device 100 has what is called a remote copy function. That is, a storage device 100, which receives write-data from a host 200, transfers this received write-data to another storage device 100 (The other storage device 100, which is the transfer destination, can be determined by an indication from a host 200, or can be decided by the storage device 100, which is carrying out the transfer.). A storage device 100, which receives write-data, stores this write-data in a storage resource under its own control. When a storage device 100, for example, transfers write-data to another storage device 100, it can switch between compressing and not compressing the write-data based on the contents of a compression control notification from the management terminal 400 just like a host 200. A detailed explanation of a storage device 100 will be given hereinbelow.

The compression function-equipped device 300, as mentioned hereinabove, is a device for compressing and decompressing data that passes through this device. The compression function-equipped device 300 can send received data to the receiving node after compressing this data, or it can send received data to the receiving node as-is without compressing this data. The compression function-equipped device 300 can switch between compressing and not compressing the data based on the contents of a compression control notification from the management terminal 400 just like a host 200 and a storage device 100. Further, in addition to the compression function, the compression function-equipped device 300 can also possess a function, for example, for mutually converting protocols when the data input interface protocol differs from the data output interface protocol, and a security-related function (for example, a function for constructing a VPN (Virtual Private Network)).

For convenience of explanation, it is supposed that this system is constituted from two hosts 200 (hostA 200a, hostB 200b), two storage devices 100 (storage device A 100a, storage device B 100b) and one management terminal 400. It is also supposed that two compression function-equipped devices 300 (compression function-equipped device A 300a, compression function-equipped device B 300b) are disposed between storage device A 100a and storage device B 100b. As shown in this figure, storage device A 100a is connected to hostA 200a, hostB 200b, and compression function-equipped devices A 300a. Further, compression function-equipped device B 300b is connected to compression function-equipped device A 300a and storage device B 100b. Furthermore, management terminal 400 is connected to all the nodes, that is, hostA 200a, hostB 200b, storage device A 100a, storage device B 100b, compression function-equipped device A 300a, and compression function-equipped device B 300b (That is, all the nodes are treated as control target nodes.). Further, hostB 200b does not have the compression function, but all the other nodes (hostA 200a, storage devices A 100a, B 100b, and compression function-equipped devices A 300a, B 300b) do have the compression function.

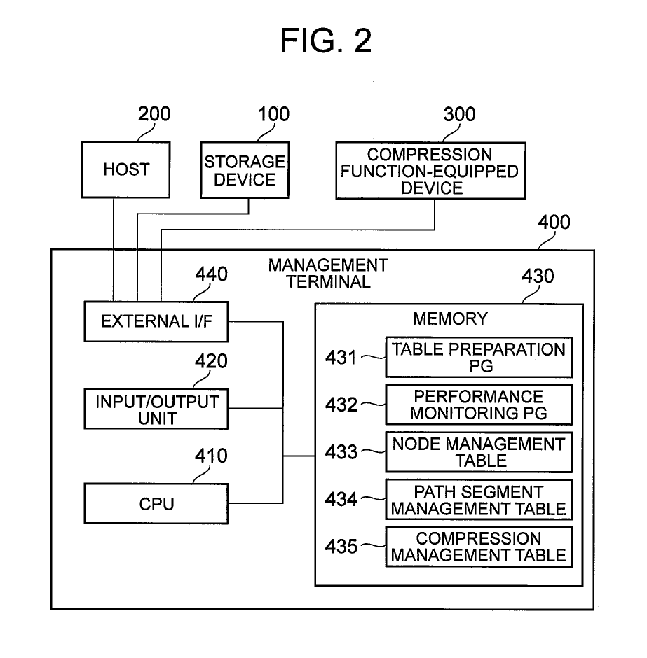

FIG. 2 is a diagram showing an example of the constitution of a management terminal 400 related to this embodiment.

The management terminal 400 comprises a CPU 410, an input/output unit 420, a memory 430, and an external I/F 440. A table preparation PG 431, performance monitoring PG 432, a node management table 433, a path segment management table 434 and a compression management table 435 are stored in the memory 430. Furthermore, “PG” is the abbreviation for program, and a block in which “PG” is assigned at the end of a name shows that the block is a computer program.

The CPU 410 controls the operation of the management terminal 400 by executing the variety of programs stored in the memory 430. For example, the CPU 410 executes the table preparation PG 431, and prepares a node management table 433, path segment management table 434, and compression management table 435. Then, the CPU 410 executes the table preparation PG 431, and distributes the prepared node management table 433 and compression management table 435 to all the control target nodes as compression control notifications. Further, the CPU 410 executes the performance monitoring PG 432, and either regularly or irregularly measures the transfer performance of the respective path segments registered in the path segment management table 434 (More specifically, for example, the CPU 410 can acquire information related to transfer performance from either one or both of the nodes, which constitute the path segment for which transfer performance is being measured (for example, the amount of data being transceived), and can compute the transfer performance based on this information), and, as necessary, changes the node management table 433 and compression management table 435. When the node management table 433 and compression management table 435 are changed, the CPU 410 executes the performance monitoring PG 432, and distributes the post-change tables (the tables changed by the CPU 410) to all of the control target nodes as compression control notifications. The processes for executing the table preparation PG 431 and performance monitoring PG 432 will be explained in detail hereinbelow.

The input/output unit 420 is the interface with the administrator for receiving input from the administrator, and notifying the administrator of prescribed information. The input/output unit 420, for example, is a keyboard or mouse for inputting, and a display for outputting.

The external I/F 440 is an interface for connecting to an external device (for example, a control target node). The management terminal 400 is respectively connected to a host 200, storage device 100 and compression function-equipped device 300 via the external I/F 440.

A node management table 433, path segment management table 434, and compression management table 435, which are stored in the memory 430, will be explained in detail hereinbelow.

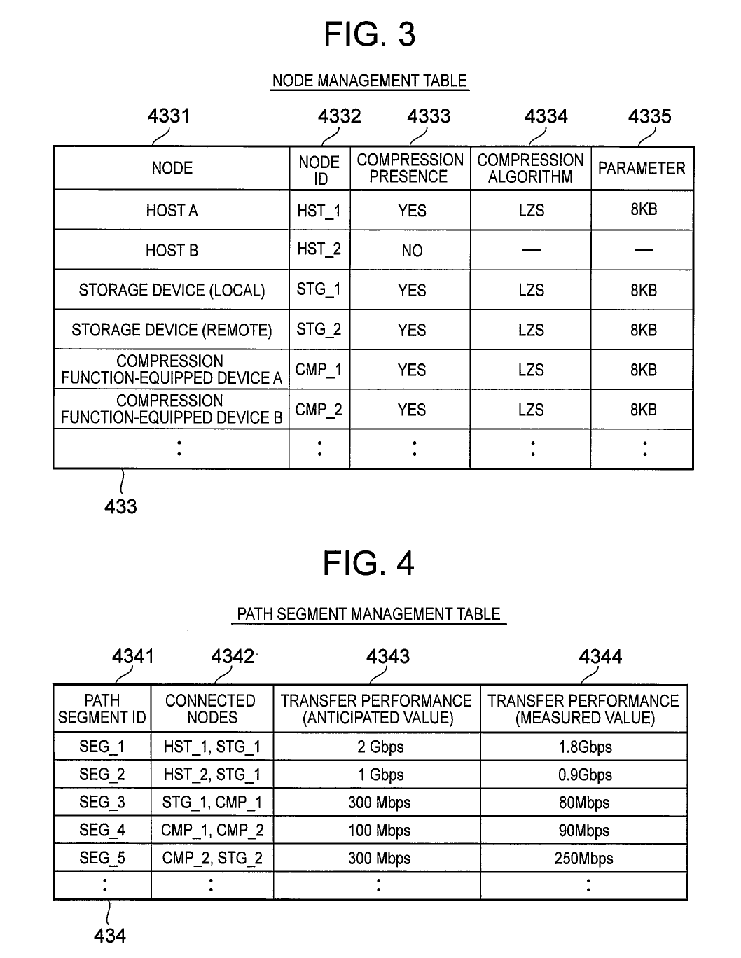

FIG. 3 is a diagram showing an example of a node management table 433.

Information related to the respective nodes is recorded in this table 433 for all the control target nodes. For example, a node name 4331, node ID 4332, compression presence 4333, compression algorithm 4334, and parameter 4335 are recorded in the node management table 433 for each control target node. The node name 4331 is information showing the name of the node. For example, when the node is the hostA 220a, “hostA” is set for the node name 4331. The node ID 4332 is an identifier for uniquely specifying a node. Compression presence 4333 is information showing whether or not the node has the compression function. For example, when the node has the compression function, “Yes” is recorded, and when the node does not have the compression function, “No” is recorded in compression presence 4333. The compression algorithm 4334 is information showing the algorithm used when the node is compressed. The “LZS” in this figure shows that compression is carried out using the LZS method in the node. The parameter 4335 is the value of the parameter of the compression algorithm 4334. For example, when the compression algorithm 4334 is “LZS”, the size of the buffer utilized when compression is carried out (hereinafter, “compression buffer size”) is recorded as the parameter. The compression buffer size, for example, is a parameter, which is called the “slide window, and generally speaking, the smaller this value, the larger the compression rate can be made. A variety of algorithms and parameters besides LZS and compression buffer size are possible, but to simplify the explanation, for this embodiment it is supposed that “LZS” is recorded as the compression algorithm 4334, and the value of the compression buffer size is recorded as the parameter 4335 when the compression function exists.

For example, in the case of this figure, referencing the node management table 433 reveals that the node, for which the node ID is “HST_{—}1”, is hostA 200a, the compression function exists, the compression algorithm is the LZS method, and the value of the compression buffer size is 8 KB. Hereinafter, a node having the node ID “HST_{—}1” will be notated as “node: HST_{—}1”. Similarly, when one of the target objects is specified by an identifier hereinbelow, this target object will be notated using a “:”.

Furthermore, the constitution of this table 433 is not limited to that described hereinabove. This table 433 can be constituted using a portion of the information elements described above, and it can be constituted by adding other, new information elements. This is the same for the path segment management table 434 and the compression management table 435, too. For example, in the case of the node management table 433, when there are a plurality of compression algorithms 4334 and parameters 4335, all of these can be included in the node management table 433.

FIG. 4 is a diagram showing an example of a path segment management table 434.

Information related to the respective path segments of all the path segments comprising a control target path is recorded in this table 434. For example, a path segment ID 4341, connected nodes 4342, anticipated transfer performance value 4343, and measured transfer performance value 4344 are recorded in the path segment management table 434 for each path segment. The path segment ID 4341 is an identifier for uniquely specifying a path segment. The connected nodes 4342 is information showing the nodes, which form the path segment, that is, the nodes at both ends of the path segment. For example, in this figure, the connected nodes 4342 for path segment: SEG_1 are “HST_{—}1, STG_{—}1”. This shows that hostA 220a, the node ID 4332 of which is “HST_{—}1”, and storage device A 100a, the node ID 4332 of which is “STG_{—}1”, constitute this path segment: SEG_1. The anticipated transfer performance value (hereinafter, simply “anticipated value”) 4343 is a value, which shows how much transfer performance the path segment normally exhibits. The anticipated value 4343, for example, is determined by taking into account the characteristics of the transmission medium utilized by the path segment, and, when the path segment is shared, the ratio at which it is used. Further, the anticipated value 4343 can be the maximum transfer performance that the path segment is capable of providing, or it can be a prescribed threshold value within the maximum transfer performance range (for example, a value arbitrarily stipulated by a user). The measured transfer performance value (hereinafter, simple “measured value”) 4344 is a measured value of the transfer performance of the path segment, which was actually measured while this system was operating. The measured value 4344 can be a value statistically determined from a plurality of measured values measured during past operations (for example, the average of a plurality of measured values), or it can be a value measured at a certain point in time. Furthermore, in this embodiment, it is supposed that communication speed is used as the transfer performance for the anticipated value 4343 and measured value 4344.

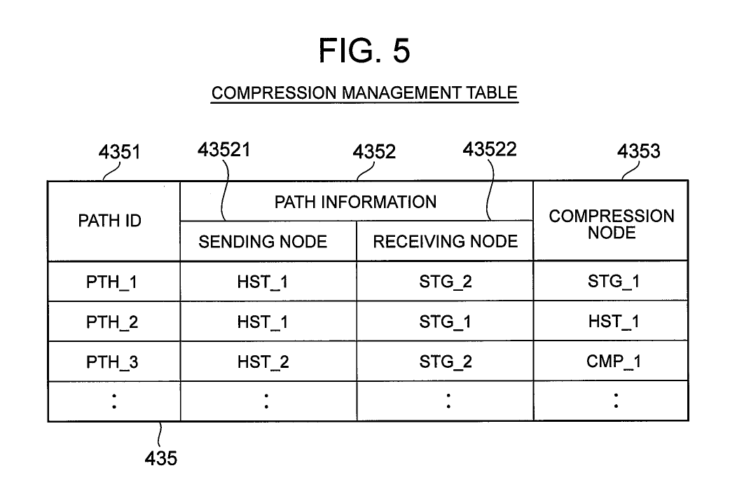

FIG. 5 is a diagram showing an example of a compression management table 435.

The nodes in which compression is carried out in the respective paths are recorded in this table 435 for all the control target paths. For example, the path ID 4351, path information 4352, and compression node 4353 are recorded in the compression management table 435 for each control target path. The path ID 4351 is an identifier for uniquely specifying a path. The path information 4352 is information for specifying a path segment, which constitutes the path.

For example, the path information 4352 comprises a sending node 43521 and a receiving node 43522 recorded as a set. The sending node 43521 is the ID of the node, which uses the path to send data. The receiving node 43522 is the ID of the node, which uses the path to receive data. Thus, when the path information 4352 is a sending node 43521 and a receiving node 43522 set, a path segment constituting the path is specified by referencing the connected nodes 4342 of the path segment management table 434. For example, for path: PTH_1, the sending node 43521 is “HST_{—}1” and the receiving node 43522 is “STG_{—}2”. Referencing the connected nodes 4342 of the path segment management table 434 here reveals that the path from “HST_{—}1” to “STG_{—}2” can be configured by linking the path segments, the connected nodes 4342 of which are respectively “HST_{—}1, STG_{—}1”, “STG_{—}1, CMP_{—}1”, “CMP_{—}1, CMP_{—}2”, and “CMP, STG_{—}2”. That is, it is clear that path: PTH_1 is constituted from path segment: SEG_1, path segment: SEG_3, path segment: SEG_4, and path segment: SEG_5.

The compression node 4353 is the ID of the node, which carries out compression in the path. The table preparation PG 431 determines the node that will carry out compression in the path based on the contents of the node management table 433 and the path segment management table 434, and sets the ID for this node in the compression nodes 4353.

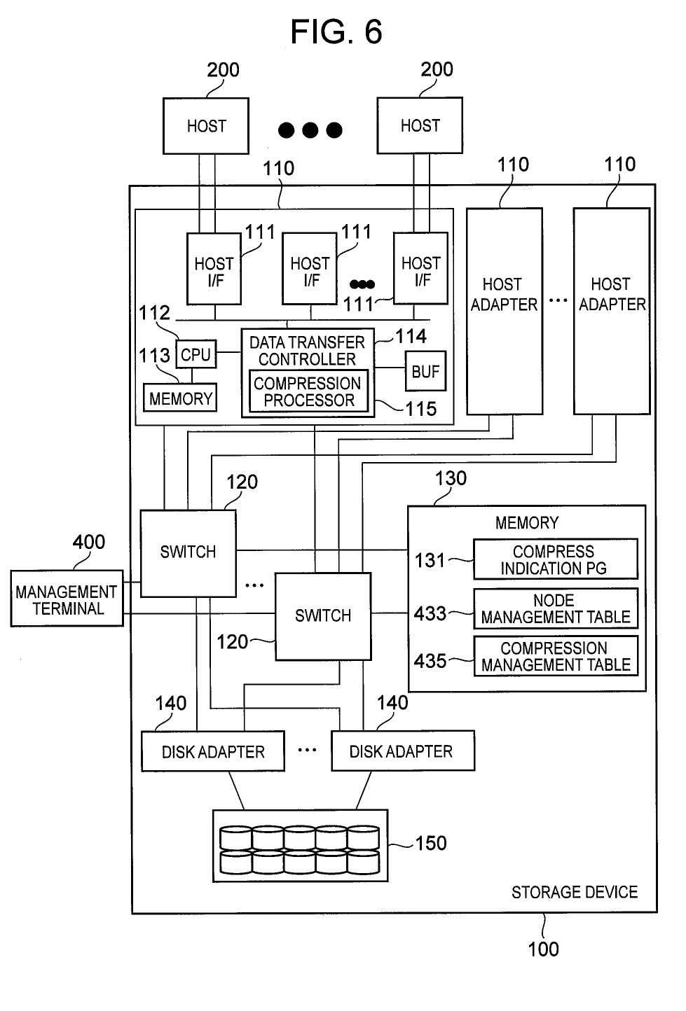

FIG. 6 is a diagram showing an example of the constitution of a storage device 100 related to this embodiment.

The storage device 100 comprises a host adapter 110, a switch 120, a memory 130, a disk adapter 140 and a disk device 150.

The host adapter 110 controls the connections between the hosts 200 and other storage devices 100. The host adapter 110 writes received data to the cache memory area of the memory 130, and reads data from the cache memory area and sends it to a host 200 or other storage device 100. The host adapter 110 comprises a host I/F 111, a CPU 112, a memory 113, a data transfer controller 114, and a compression processor 115.

The host I/F 111 is an interface for connecting to either a host 200 or another storage device 100. The host I/F 111 carries out processing related to a corresponding protocol (for example, fibre channel, FICON (Fiber Connection) or iSCSI (internet SCSI)) in accordance with the connection mode. For example, the host I/F 111 reconstructs original write-data from packet data received from a host 200, creates packet data from read-data, and sends this packet data to a host 200.

The CPU 112 controls the respective units inside the host adapter 110. For example, the CPU 112 executes a compress indication PG 131, which is stored in the memory 130, and, in accordance with the contents of a compression control notification from the management terminal 400, indicates whether or not the compression processor 115 is to perform compression.

The memory 113 is an area for storing data and programs, which are read and executed by the CPU 112. Furthermore, the compress indication PG 131, which will be explained below, the node management table 433 and the compression management table 435 can be stored in this memory 113.

The data transfer controller 114 controls the transfer of data received from a host 200 or other storage device 100. For example, the data transfer controller 114 writes write-data to the disk device 150 or memory 130 in accordance with a command received together with the write-data, and transfers the write-data to another storage device 100 in accordance with an indication from the CPU 112 (can also be transferred via the memory 130). Further, the data transfer controller 114 reads out read-data from the disk device 150 or the memory 130, and transfers this read-data to a host 200, and transfers read-data received from another storage device 100 to a host 200.

The memory 130 has a cache memory area, which is used for temporarily storing data transceived to/from a host computer 200 (or another storage device 100); and a shared memory area, which is used for storing control information and configuration information related to the storage device 100. The compress indication PG 131, node management table 433 and compression management table 435 are stored in the shared memory area.

The disk adapter 140 controls the connection with a disk device 150. The disk adapter 140 reads data from the cache memory area and writes it to a disk device 150, and reads data from a disk device 150 and writes it to the cache memory area.

A disk device 150 is a storage resource, which the storage device 100 provides to a host 200. For example, write-data received from a host 200 is stored in a disk device 150.

A switch 120 respectively connects a host adapter 110, the memory 130 and a disk adapter 140. Further, the storage device 100 is connected to the management terminal 400 via a switch 120.

Furthermore, in this embodiment, a host adapter 110, the memory 130 and a disk adapter 140 are connected by a switch 120, but they could also be connected by a bus.

Further, instead of being comprised of a host adapter 110 and disk adapter 140, respectively, the present invention can also be comprised of a single device, which combines both functions.

Further, the compression processor 115 does not necessarily have to be provided inside the data transfer controller 114, and can be provided any place inside the storage device 100. For example, the compression processor 115 can be provided in a disk adapter 140, or it can be stored in either memory 113 or 130 as a computer program for carrying out compression processing.

Further, the cache memory and shared memory areas of memory can be secured any place inside the storage device 100. For example, cache memory and shared memory can be secured as separate memories.

Further, the processors can also be provided any place inside the storage device 100. For example, the processors can be consolidated to take the form of a dedicated adapter for processors.

Furthermore, a detailed explanation of the constitutions of a host 200 and compression function-equipped device 300 will be omitted, but it is supposed that a host 200 and compression function-equipped device 300 comprise a CPU 112, a compression processor 115 and a memory 130 just like a storage device 100, and that a compress indication PG 131, node management table 433 and compression management table 435 are stored in memory.

The operations of the respective devices constituting the storage system will be explained hereinbelow. Furthermore, when a computer program is the subject, the processing is actually carried out by the CPU, which executes this computer program.

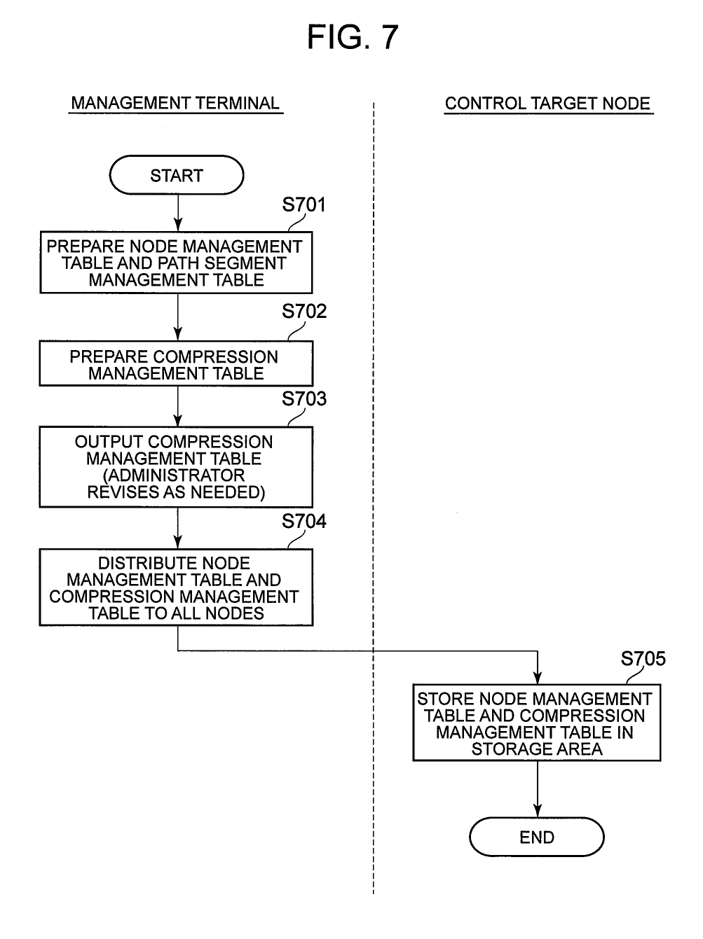

FIG. 7 is a flowchart of processing executed by the table preparation PG 431.

First, the table preparation PG 431 prepares a node management table 433 and a path segment management table 434 (S701). The information recorded in these tables (with the exception of a measured value 4344), for example, can be inputted by the administrator via the input/output unit 420, or can be automatically acquired by using an application or the like, which searches the network. By contrast, a measured value 4344, for example, is treated as an initial value, and is considered to be the same as the anticipated value 4343 for each path segment. It is supposed here that the node management table 433 and path segment management table 434 are prepared as shown in FIGS. 3 and 4, respectively, except for the measured value 4344.

Next, the table preparation PG 431 prepares a compression management table 435 based on the node management table 433 and the path segment management table 434 (S702). The information recorded in the compression management table 435 (with the exception of the compression node 4353), is the same as when preparing the above-mentioned node management table 433 and path segment management table 434, and, for example, can be inputted by the administrator via the input/output unit 420, or can be automatically acquired by using an application or the like, which searches the network. Therefore, the determination of a path registered in the compression management table 435, that is, a control target path, can be carried out by the administrator, or it can be carried out automatically. It is supposed here that the compression management table 435 is prepared as shown in FIG. 5, except for the compression node 4353.

By contrast, the compression node 4353 is treated as the ID of a node, which the table preparation PG 431 determines based on the contents of the node management table 433 and path segment management table 434. The table preparation PG 431, for example, can determine a compression node 4353 as follows.

That is, the table preparation PG 431 can determine a compression node 4353 based on the arrangement of the nodes on a path. If explained using path: PTH_1 in FIG. 5 as an example, as described hereinabove, this path is constituted from path segments, the connected nodes 4342 of which are respectively “HST_{—}1, STG_{—}1”, “STG_{—}1, CMP_{—}1”, “CMP_{—}1, CMP_{—}2”, and “CMP, STG_{—}2” (This can be understood by referencing the path segment management table 434.). Therefore, it is clear that hostA 200a, storage device A 100a, compression function-equipped device A 300a, compression function-equipped device B 300b, and storage device B 100b reside on path: PTH_1 in order from the upstream of the data flow. Furthermore, it is also clear from the node management table 433 that all of these nodes possess the compression function. Accordingly, so as to avoid duplication of compression and achieve efficient transmission, the table preparation PG 431 can decide that compression be carried out only for the hostA 200a, which is located the furthest upstream. In other words, in this case, the table preparation PG 431 makes “HST_{—}1” the compression node 4353 of path: PTH_1.

Further, beside the arrangement of the nodes, the table preparation PG 431 can also determine a compression node 4353 by taking into account the anticipated value 4343 of the path segment constituting the path. As described hereinabove, path: PTH_1 is constituted from path segment: SEG_1, path segment: SEG_3, path segment: SEG_4, and path segment: SEG_5. The lowest anticipated value 4343 of these path segments was that of path segment: SEG_4 at “100 Mbps”. That is, path segment: SEG_4 is the bottleneck on path: PTH_1. Accordingly, the table preparation PG 431 can decide that compression be carried out only immediately prior to this path segment: SEG_4, that is, in compression function-equipped device A 300a. In other words, in this case, the table preparation PG 431 makes “CMP1” the compression node 4353 of path: PTH_1.

Thereafter, the table preparation PG 431 notifies the administrator of the prepared tables (the node management table 433, path segment management table 434, and compression management table 435) via the input/output unit 420 (S703). The administrator can revise these tables prepared by the table preparation PG 431 as needed. Furthermore, notifications to this administrator and revisions by this administrator are not always necessary.

Thereafter, the table preparation PG 431 distributes the prepared node management table 433 and compression management table 435 to all the control target nodes as a compression control notification (S704).

A control target node, which receives a compression control notification, stores the node management table 433 and compression management table 435 received together with this notification in a storage area of its own (S705). For example, in the case of a storage device 100, the received node management table 433 and compression management table 435 are stored in the memory 130.

The preceding is an explanation of the flowchart of processing executed by the table preparation PG 431.

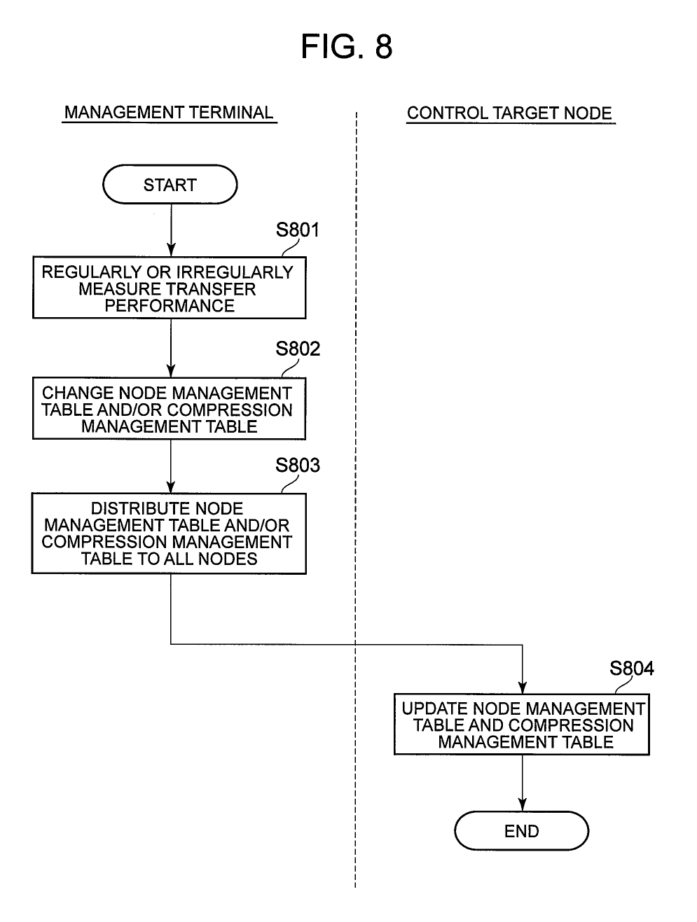

FIG. 8 is a flowchart of processing executed by the performance monitoring PG 432.

First, when the performance monitoring PG 432 is activated, the performance monitoring PG 432 measures either regularly or irregularly the transfer performance in each path segment registered in the path segment management table 434 (S801). The measurement of transfer performance for a path segment, for example, is carried out by the performance monitoring PG 432 acquiring information related to transfer performance (for example, the amount of data being transceived) from either one or both of the nodes constituting this path segment, and computing the transfer performance based on this information. The results of measurement are recorded in the path segment management table 434.

Thereafter, when a prescribed change occurs in transfer performance, the performance monitoring PG 432 changes the node management table 433 and/or the compression management table 435 (S802). The performance monitoring PG 432, for example, can change these tables 433, 435 under the following circumstances.

That is, it is supposed that the measured value 4344 of path segment: SEG_4 is 50 Mbps. In this case, the measured value 4344 is one-half the communication speed of the anticipated value 4343 of “100 Mbps”, making it clear that communication performance is extremely low. Accordingly, the performance monitoring PG 432 can opt to increase the compression rate at the time of compression in the node immediately prior to this path segment: SEG_4 (for example, in compression function-equipped device A 300a, when data is flowing from compression function-equipped device A 300a to compression function-equipped device B 300b). That is, the performance monitoring PG 432 can change the parameter 4345 of node: CMP_1 (here, the compression buffer size) in the node management table 433 so that it becomes smaller.

Further, the node subjected to compression can also be changed in accordance with a change in the measured value 4344. For example, it is supposed that since path segment: SEG_4 is expected to become the bottleneck based on the anticipated value 4343, the measured value 4344 will be as shown in FIG. 4 when “CMP_{—}1” is made the compression node 4353 of path: PTH_1. In this case, the path segment that is actually the bottleneck is path segment: SEG_3. Accordingly, the performance monitoring PG 432 can make the node immediately prior to this path segment: SEG_3 (in the case of path: PTH_1, this is storage device A 100a) the compression node 4353 of path: PTH_1. That is, the performance monitoring PG 432 changes the compression node 4353 of path: PTH_1 in the compression management table 435 from “CMP_{—}1” to “STG_{—}1”.

Thereafter, the table preparation PG 431 distributes the changed tables (node management table 433 and/or compression management table 435) to all control target nodes as a compression control notification (S803).

A control target node, which receives a compression control notification, updates the node management table 433 and/or compression management table 435 stored in its own storage area to the contents of the tables received from the performance monitoring PG 432 (the node management table 433 and/or compression management table 435) (S804).

The preceding is an explanation of the flowchart of processing executed by the performance monitoring PG 432.

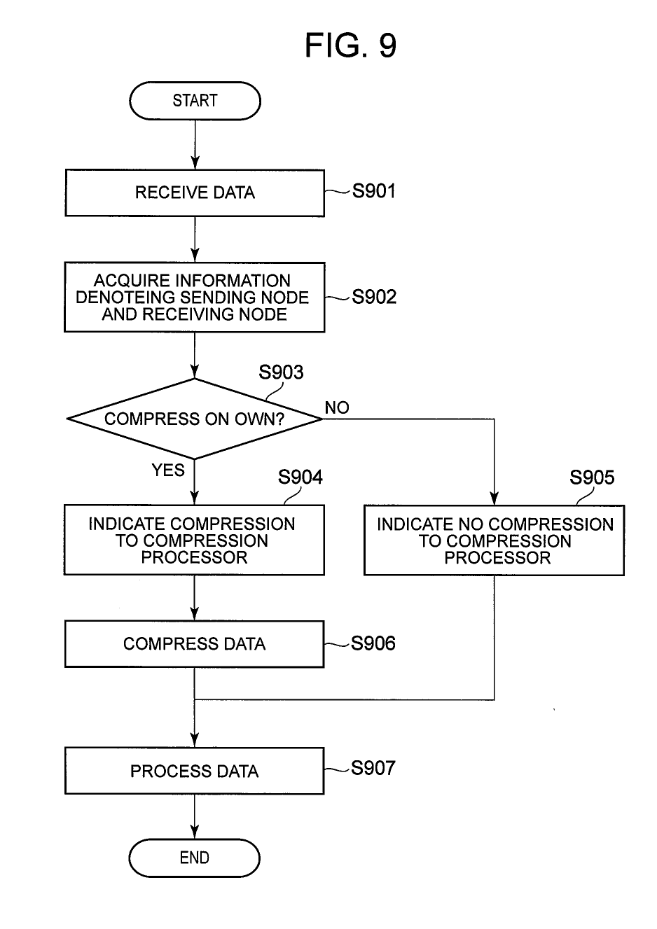

FIG. 9 is a flowchart of processing executed when a control target node receives data.

This processing will be explained here as storage device A 100a executing the compress indication PG 131. Further, it is supposed that the node management table 433 and compression management table 435 stored in the memory 130 are as shown in FIGS. 3 and 5, respectively.

First, the storage device A 100a receives data (S901). For example, a write command and write-data are received from hostA 200a.

The storage device A 100a acquires from the write command received together with the write-data information showing the sending node and receiving node of the write-data (S902). It is supposed here that the sending node is hostA 200a(HST_1), and the receiving node is storage device B 100b (STG_2).

At this point, the compress indication PG 131 determines whether or not to compress the write-data on its own (that is, the storage device A 100a) (S903). This determination is made as follows.

That is, the compress indication PG 131 first references the compression management table 435 stored in the memory 130, and, based on the information showing the sending node and receiving node acquired in S902, determines the path on table 435, which is equivalent to the path through which the write-data passes. Since the sending node is the hostA 200a (HST_1) and the receiving node is the storage device B 100b (STG_2) here, path: PTH_1 corresponds to the path through which the write-data passes. Next, the compress indication PG 131 references the compression node 4353 of the path through which the write-data passes, that is, of path: PTH_1, and makes a determination to carry out compression if it itself (that is, STG_1) is the compression node 4353, and makes a determination not to carry out compression if the compression node 4353 is a device other than itself. In FIG. 5, since the compression node 4353 of path: PTH_2 is “STG_1”, the compress indication PG 131 makes the determination to compress the write-data itself.

Thereafter, the compress indication PG 131, based on the determination result in S903, issues an indication to the compression processor 115 as to whether compression is carried out or not carried out for the write-data (hereinafter, “compression/no compression indication”) (S904, S905). When an indication to carry out compression is issued, the compression algorithm 4334 and parameter 4335 to be used in this compression are also notified. The compress indication PG 131 can reference the node management table 433, and acquire a compression algorithm 4344 and parameter 4345 to use when it carries out compression itself. At this point, “LZS”, which is the compression algorithm 4344 of node: STG_1, and “8 KB”, which is the parameter 4345 of node: STG_1, are notified to the compression processor 115. Furthermore, only when the determination in S903 is to carry out compression can an indication to this effect be issued to the compression processor 115 together with the compression algorithm 4334 and parameter 4335.

When the indication is to carry out compression, the compression processor 115, which receives the compression/no compression indication, uses the compression algorithm 4344 and parameter 4345 notified together with the compression indication to compress the write-data (S906).

Thereafter, the storage device A 100a processes the write-data based on this control data (S907). That is, the storage device A 100a transfers the write-data to storage device B 100b.

Furthermore, since all of the control target nodes on the path through which the write-data will pass (hostA 200a, storage A 100a, compression function-equipped device A 300a, compression function-equipped device B 300b, and storage device B 100b) have the same node management table 433 and compression management table 435, the write-data is compressed by no other device except storage device A 100a. Therefore, the risk of the write-data being redundantly compressed is eliminated.

The preceding is an explanation of the flowchart of processing executed when a control target node receives data.

According to this embodiment, it is possible to efficiently compress data transceived in the storage system because the redundant compression of data can be avoided, and the compression rate thereof can be changed as needed when transfer performance deteriorates.

### Second Embodiment

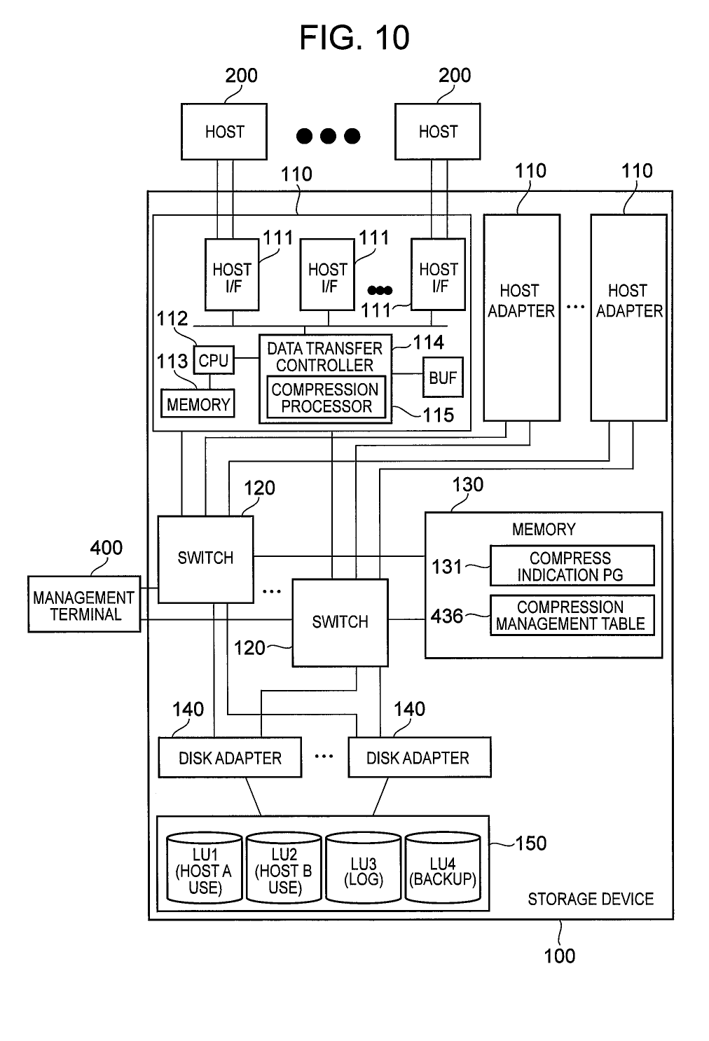

FIG. 10 is a diagram showing an example of the constitution of a storage system comprising a compression control device related to a second embodiment of the present invention.

A storage system related to this embodiment comprises one or more hosts 200, a storage device 100 and a management terminal 400.

The constitutions of the hosts 200, storage device 100 and management terminal 400 are the same as those of the first embodiment for the most part. The differences with the first embodiment will mainly be explained hereinbelow.

A host 200 does not necessarily have to store a compress indication PG 131, node management table 433 and compression management table 435. Otherwise, the host 200 is the same as that in the first embodiment.

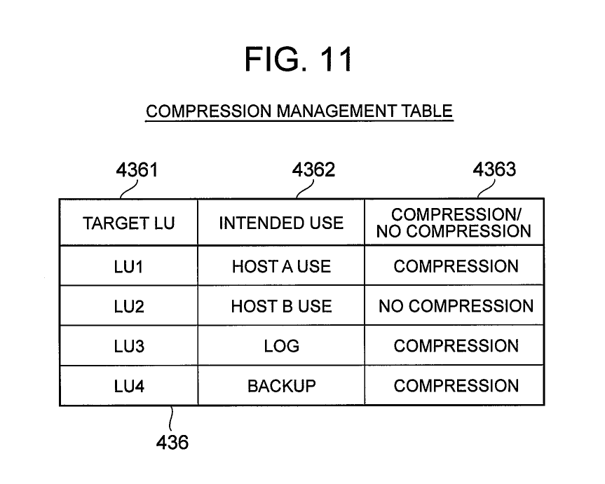

The management terminal 400 does not necessarily have to store the performance monitoring PG 432, node management table 433 and path segment management table 434 in the memory 430. Further, the processing executed by the table preparation PG 431 differs in part from that explained in FIG. 7. More specifically, in this embodiment, the processing of S701 is not considered necessary, and the node management table 433 does not have to be distributed and stored in S704 and S705. In this embodiment, the table preparation PG 431 prepares a compression management table 436 as shown in FIG. 11, and delivers the prepared compression management table 436 to the storage device 100. Otherwise, the management terminal 400 is the same as that in the first embodiment.

The storage device 100 does not necessarily have to store the node management table 433 in the memory 130. Further, the disk device 150 comprises a plurality of logical volumes, for example, a logical volume used by hostA 200a (shown as “LU1” here), a logical volume used by hostB 200b (shown as “LU2” here), a logical volume for storing a log (shown as “LU3” here), and a logical volume for storing backup data (shown as “LU4” here). Furthermore, “LU” is the abbreviation for Logical Unit. Further, the compress indication PG 131 in this embodiment references the compression management table 436, and determines whether or not data is compressed based on the volume in which this data is stored. This will be explained in detail below. Otherwise, the storage device 100 is the same as that in the first embodiment.

FIG. 11 is a diagram showing an example of a compression management table 436 related to this embodiment.

Whether or not compression is carried out for data stored in a logical volume is recorded in this table 436 for each logical volume comprising the disk device 150. For example, target LU 4361, intended use 4362, and compression/no compression 4363 are recorded in the compression management table 436. Target LU 4361 is information for specifying the logical volume. Intended use 4362 is information showing the intended use of the logical volume, for example, a host (or application), which uses the logical volume, or the type of data stored in the logical volume. For example, when the logical volume is used by host A, the intended use 4362 is designated “host A use”, and when the logical volume is used to store a log, the intended use 4362 is designated “log” and so forth. Furthermore, intended use 4362 does not necessarily have to be recorded. Compression/no compression 4363 is information as to whether or not compression is carried out for data stored in the logical volume. For example, when compression is to be carried out, compression/no compression 4363 is set to “compression”, and when compression is not to be carried out, compression/no compression 4363 is set to “no compression”, respectively. Compression/no compression 4363, for example, is determined as “no compression” when the data stored in the logical volume is used with high frequency, and is determined as “compression” when the utilization frequency is low. For example, since a log and backup data are data, which are used mainly when a fault occurs in the system, utilization frequency is low. Therefore, the compression/no compression 4363 of LU3 and LU4, in which logs and backup data are stored, can be set to “compression”. Further, when the frequency of access from hostA 200a is low (the utilization frequency of the data stored in LU1 is low), compression/no compression 4363 for LU1 can be set to “compression”. Conversely, when the frequency of access from hostB 200b is high, compression/no compression 4363 for LU2 can be set to “no compression”.

Furthermore, this table 436 does not necessarily have to be recorded for each logical volume. For example, information showing a plurality of logical volumes having the same intended use can be set in target LU 4361, and this table 436 can be recorded with information for each plurality of logical volumes.

Further, as described hereinabove, this table 436 is prepared by the table preparation PG 431 in the management terminal 400. Therefore, information recorded in this table 436 can be inputted by the administrator via the input/output unit 420 the same as in the first embodiment. This information can also be acquired automatically using an application, which searches the network.

The operation of the storage device 100 of this embodiment will be explained hereinbelow.

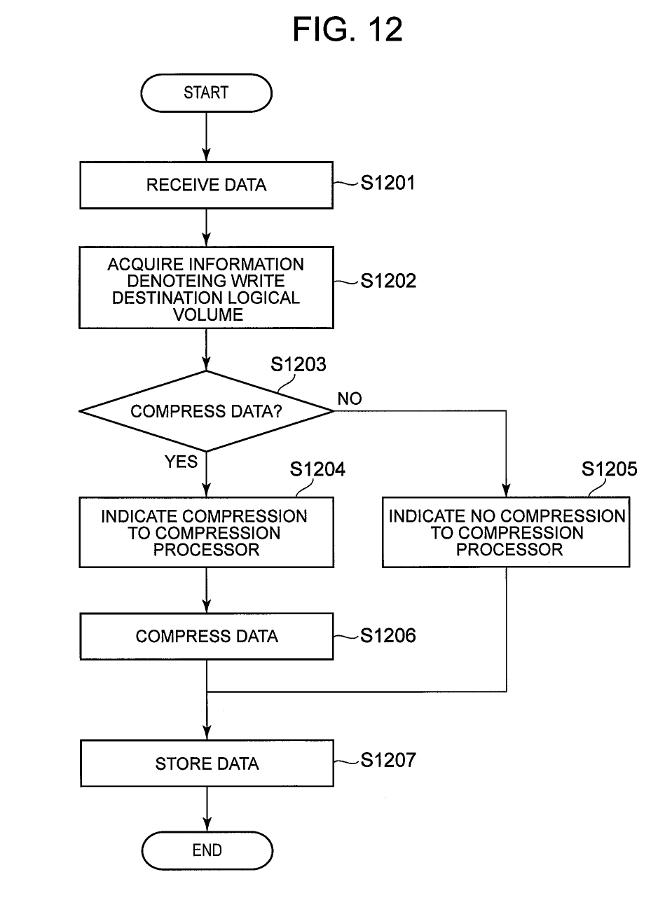

FIG. 12 is a flowchart of processing executed when the storage device 100 receives data.

First, the storage device 100 receives data (S1201). For example, a write command and write-data are received from a host 200.

The storage device 100 acquires information from the write command received together with the write-data, showing the logical volume in which the write-data is stored (for example, the LUN (Logical Unit Number)) (S1202).

At this point, the compress indication PG 131 references the compression management table 436, and determines whether or not the write-data is to be compressed (S1203). For example, the compression management table 436 is as shown in FIG. 11, and when the logical volume in which the write-data is stored is LU1, “compression” is set in the compression/no compression 4363 for LU1, thus prompting a determination to carry out compression.

Thereafter, the compress indication PG 131 issues a compression/no compression indication to the compression processor 115 for the write-data based on the determination result in S1203 (S1204, S1205). Furthermore, only when the determination in S1203 is that compression is to be carried out can an indication to this effect is issued to the compression processor 115.

The compression processor 115, which receives a compression/no compression indication, compresses the write-data when compression is indicated (S1206).

Thereafter, the storage device 100 stores the write-data in the logical volume shown in the information acquired in S1202 (S1207).

Furthermore, in the flowchart of FIG. 12, an example of when a determination is made as to whether or not compression is to be carried out for write-data received from a host 200 is explained, but the present invention is not limited to this. For example, a disk adapter 140 can comprise a CPU 112 and a compression processor 115, the CPU 112 inside the disk adapter 140 can execute the compress indication PG 131, and the compression processor 115 inside the disk adapter 140 can carry out compression control. By so doing, a determination as to whether or not compression is to be carried out is not limited to write-data received from a host 200, but rather can be made for data stored in the disk device 150 from the cache memory area. In other words, when data stored in the disk device 150 from the cache memory area is a log or backup data (logs and backup data are often created inside the storage device 100), this data can be stored in the disk device 150 after being compressed in the disk adapter 140.

The flowchart of processing executed when the storage device 100 receives data is explained hereinabove.

According to this embodiment, since compression can be carried out for low-utilization-frequency data, data stored in a storage resource of the storage system can be efficiently compressed, and the amount of capacity used in a storage resource can be efficiently held in check.

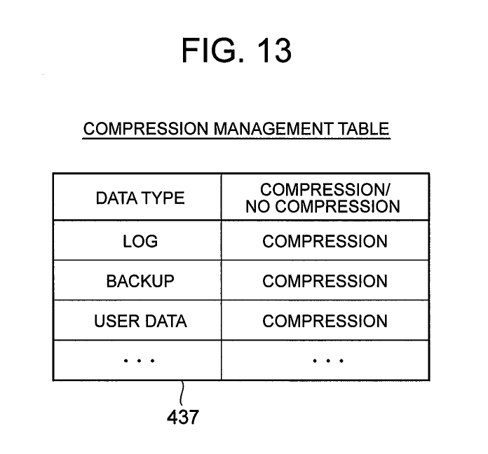

The several embodiments of the present invention described hereinabove are examples for explaining the present invention, and do not purport to limit the scope of the present invention solely to these embodiments. The present invention can be put into practice in a variety of other modes without departing from the gist thereof. For example, the compression management table 437 shown in FIG. 13 can be prepared. In this case, the compression processor 115 can decide whether to compress (or decompress) data based on the data type of the data to be written (or read out) and the compression management table 437 of FIG. 13.

What is claimed is:

1. A compression control device, which controls the compression of data transceived in a storage system constituted by a plurality of apparatuses which include a storage device, the compression control device comprising:
configuration information related to the configuration of the storage system;
a compression control method decision unit that decides a compression control method for at least one apparatus constituting the storage system based on the configuration information; and
a compression control unit that controls at least one of the plurality of apparatuses such that the at least one apparatus carries out compression in accordance with the decided compression control method.

2. The compression control device according to claim 1, wherein the configuration information comprises apparatus information and communication channel information,
the apparatus information denotes whether or not each of the plurality of apparatuses constituting the storage system has the compression function,
the communication channel information denotes, for each of a plurality of communication channels formed by the plurality of apparatuses constituting the storage system, a combination of apparatuses which form the communication channel, and the order in which data flows for the plurality of apparatuses forming the communication channel,
the compression control method decision unit decides, for each of the plurality of the communication channels and based on the apparatus information and the communication channel information, one of the plurality of apparatuses forming the communication channel is a compression execution apparatus which is the apparatus that carries out data compression, and
the compression control unit controls at least one of the plurality of apparatuses such that the decided compression execution apparatus carries out data compression for each of the communication channels.

3. The compression control device according to claim 2, wherein the compression control method decision unit decides, for each of the communication channels and based on the apparatus information and the communication channel information, that the apparatus located the furthest upstream in the data flow, among the apparatuses which are a plurality of apparatuses forming the communication channel and which have the compression function, is the compression execution apparatus.

4. The compression control device according to claim 2, wherein the configuration information further comprises transfer performance information,
the transfer performance information denotes, for each of the communication channels, the transfer performance in each communication segment of the communication channel, and
the compression control method decision unit decides, for each of the communication channels and based on the apparatus information, the communication channel information and the transfer performance information, that the apparatus located immediately prior to a low-transfer-performance communication segment, among the apparatuses which are a plurality of apparatuses forming the communication channel and which have the compression function, is the compression execution apparatus.

5. The compression control device according to claim 4, wherein the transfer performance is a data communications speed.

6. The compression control device according to claim 4, wherein the transfer performance is an anticipated value of the data communications speed.

7. The compression control device according to claim 4, further comprising:
a transfer performance measurement unit that measures, either regularly or irregularly, the transfer performance of communication segments in each of the communication channels,
wherein the transfer performance shown by the transfer performance information is either (1) or (2) below:
(1) transfer performance at a prescribed point in time measured by the transfer performance measurement unit; or
(2) an average transfer performance value at a plurality of points in time measured by the transfer performance measurement unit.

8. The compression control device according to claim 7, wherein the transfer performance information denotes a history of transfer performances,
the histories of the transfer performance for each of the communication segments in each of the communication channels are updated by adding a transfer performance measured by the transfer performance measurement unit,
wherein the compression control device further comprises a performance change determination unit which determines, for each of the communication channels, whether or not the low-transfer-performance communication segment has shifted to another communication segment, and
when the performance change determination unit determines that the low-transfer-performance communication segment has shifted to another communication segment for a certain communication channel, the compression control method decision unit decides that the apparatus which is located immediately prior to the other low-transfer-performance communication segment and which has the compression function is the compression execution apparatus for the certain communication channel, and the compression control unit controls at least one of the plurality of apparatuses such that the decided compression execution apparatus carries out data compression for the certain communication channel.

9. The compression control device according to claim 8, wherein the compression control method decision unit adjusts, based on transfer performance subsequent to the shift of the low-transfer-performance communication segment, the compression rate when the decided compression execution apparatus compresses data, and
the compression control unit sends the adjusted compression rate to the compression execution apparatus.

10. The compression control device according to claim 1, wherein the configuration information comprises transfer performance information which denotes, for each communication channel, the transfer performance of each communication segment in the communication channel,
the compression control method decision unit decides, based on the transfer performance shown by the transfer performance information, either a compression rate or a parameter that affects the compression rate when the compression execution apparatus, which is the apparatus that carries out compression among the plurality of apparatuses, compresses data, and
the compression control unit sends either the decided compression rate or parameter to the compression execution apparatus.

11. The compression control device according to claim 10, further comprising a transfer performance measurement unit, which either regularly or irregularly measures the transfer performance of the communication segment, and which updates the transfer performance information such that the transfer performance shown by the transfer performance information is the measured transfer performance,
wherein the compression control method decision unit changes either the compression rate or the parameter that affects the compression rate when the compression execution apparatus compresses data, based on the transfer performance shown by updated transfer performance information, and
the compression control unit sends either the updated compression rate or parameter to the compression execution apparatus.

12. The compression control device according to claim 1, wherein the configuration information comprises data type information denoting the type of data in the storage system,
the compression control method decision unit decides whether or not to carry out data compression for each data type based on the data type information for a prescribed apparatus which constitutes the storage system, and
the compression control unit controls the prescribed apparatus such that the prescribed apparatus carries out data compression for the data type decided by the compression control method decision unit.

13. The compression control device according to claim 12, wherein when the data type is either a log or a backup, the compression control method decision unit decides that compression of the data is carried out.

14. The compression control device according to claim 12, wherein the configuration information comprises logical volume information, which denotes identification information for a logical volume in which data handled by the prescribed apparatus is stored, and the intended use therefor,
the compression control method decision unit decides, based on the intended use of each of logical volumes indicated in the logical volume information, whether or not to carry out compression of data stored in the logical volume for each of the logical volumes for a prescribed apparatus constituting the storage system, and
the compression control unit controls the prescribed apparatus such that the prescribed apparatus carries out the compression of data stored in the logical volume decided by the compression control method decision unit.

15. A compression control system, comprising:
a plurality of apparatuses which include a storage device; and
a compression control device,
the compression control device comprising:
configuration information related to the configuration of the plurality of apparatuses;
a compression control method decision unit for deciding a compression control method for at least one apparatus of the plurality of apparatuses based on the configuration information; and
a compression control unit for controlling at least one of the plurality of apparatuses such that the at least one apparatus carries out compression in accordance with the decided compression control method.

16. A compression control method, comprising the steps of:
deciding a compression control method for at least one apparatus constituting a storage system constituted by a plurality of apparatuses which include a storage device, based on the configuration information related to the configuration of the storage system; and
controlling at least one of the plurality of apparatuses such that the at least one apparatus carries out compression in accordance with the decided compression control method.
